(19) United States
(12) Patent Application Publication
(10) Pub. No.: US 2017/0247818 A1
(43) Pub. Date: Aug. 31, 2017

(54) ANTISEPTIC 3D PRINTING FILAMENT

(71) Applicant: Chin-Yen Yang, New Taipei City (TW)

(72) Inventor: Chin-Yen Yang, New Taipei City (TW)

(21) Appl. No.: 15/052,877

(22) Filed: Feb. 25, 2016

(51) Int. Cl. D02G 3/44

(52) U.S. Cl. CPC D02G 3/449; D02G 3/447; B33Y 70/00

(57) ABSTRACT

The antiseptic 3D printing filament contains the following coaxial layers arranged radially outside-in: an antiseptic layer, a color layer inside and next to the antiseptic layer, a support layer inside and next to the color layer, and a resin layer inside and next to the support layer. The antiseptic layer, the color layer, and the support layer are melted and joined to the resin layer with a temperature between 100 and 500 degrees Celsius and the filament diameter is between 0.80 and 3.20 mm. When an object is produced from a 3D printer using the filament, the produced object is antiseptic without additional coating or spraying antiseptic material, thereby reducing production time and effort. The filament is also prevented from contamination with prolonged antiseptic capability.

### BACKGROUND OF THE INVENTION

(a) Technical Field of the Invention

The present invention is generally related to 3D printing filament, and more particular to an antiseptic 3D printing filament.

(b) Description of the Prior Art

3D printing refers to various processes used to synthesize a three-dimensional object by successive stacking layers of powdered metal or plastic material in accordance with a digital 3D model. There are various types of 3D printing such as selective laser sintering (SLS), fused deposition modeling (FDM), or fused filament fabrication (FFF) that melts or softens the material to produce the layers; or such as stereolithography (SLA), laminated object manufacturing (LOM) that prints and cures liquid materials. Depending on the material used, the 3D printing method is determined accordingly. Usually a user selects a specific material according to the desired object, and then selects the printing method according to the material.

The 3D-printed objects can be of almost any shape or geometry. But if the object has to be antiseptic, an additional coating or spraying of antiseptic material is required. This is an inconvenient process. If the material used is not antiseptic, the material can be contaminated already before printing, or the printed object is already contaminated.

### SUMMARY OF THE INVENTION

A major objective of the present invention is to incorporate an antiseptic layer in the 3D printing filament so that a 3D-printed object is antiseptic without additional coating or spraying antiseptic material, thereby reducing production time and effort. The filament is also prevented from contamination with prolonged antiseptic capability.

The antiseptic 3D printing filament contains the following coaxial layers arranged radially outside-in: an antiseptic layer, a color layer inside and next to the antiseptic layer, a support layer inside and next to the color layer, and a resin layer inside and next to the support layer. The support layer helps improving the fluidity, ductility, heat resistance, anti-oxidation, anti-UV capability of the antiseptic layer, the color layer, and the resin layer. The color layer colors the support layer and is colorless or has one of the color black, purple, white, green, orange, silver, blue, pink, yellow, and red. When an object is produced from a 3D printer using the filament, the object is immediately antiseptic.

The present invention therefore obviates the shortcoming of the prior art that requires additional coating or spraying of antiseptic material, and therefore is more time consuming and less effective.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an antiseptic 3D printing filament according to an embodiment of the present invention.

FIG. 2 is a cross-sectional diagram showing the antiseptic 3D printing filament along the A-A line of FIG. 1.

FIG. 3 is a perspective diagram showing the antiseptic 3D printing filament of FIG. 1 applied to a 3D printer.

FIG. 4 is a perspective diagram showing an object produced from the 3D printer of FIG. 3. FIG. 5 is a cross-sectional diagram showing an antiseptic 3D printing filament according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims

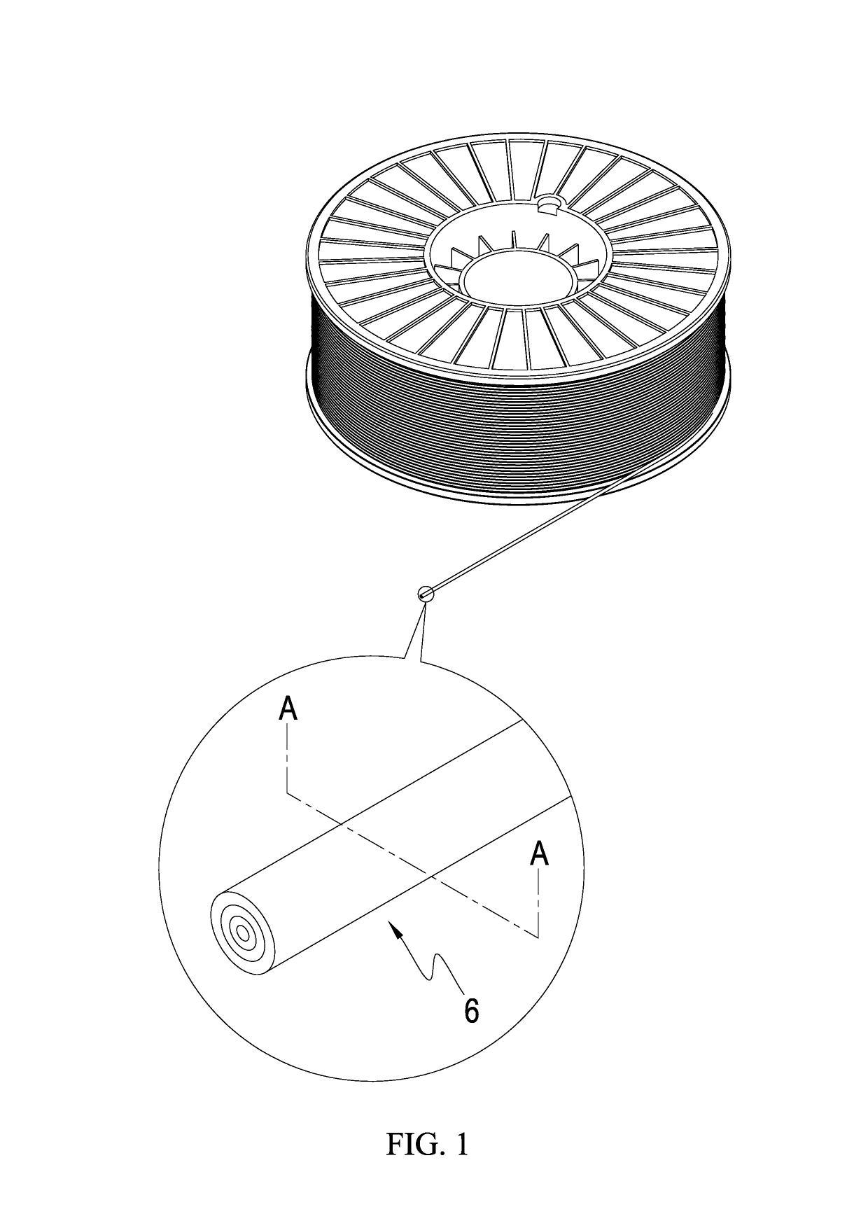

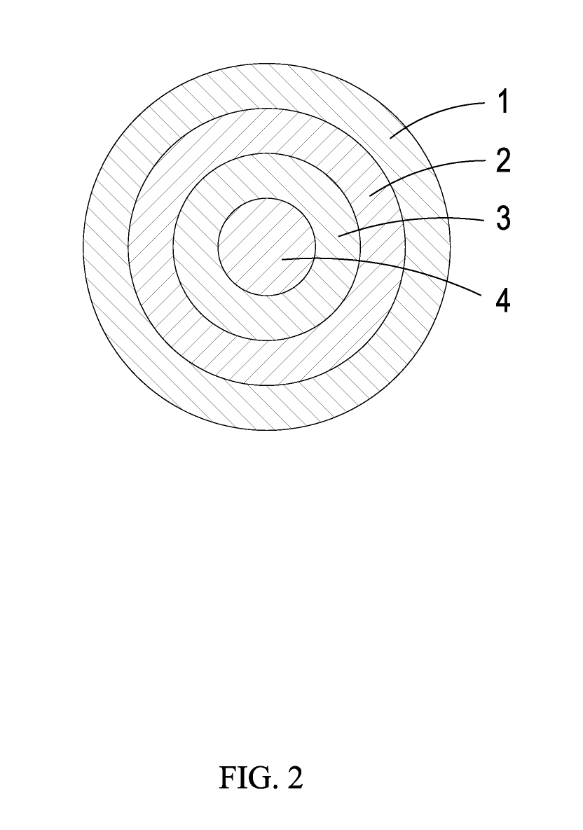

As shown in FIGS. 1 and 2, an antiseptic 3D printing filament 6 according to an embodiment of the present invention contains the following coaxial layers arranged radially outside-in.

An antiseptic layer 1 is the outmost layer.

A color layer 2 is inside and next to the antiseptic layer 1. The color layer 2 is made of toner or color masterbatch, and is colorless or has one of the color black, purple, white, green, orange, silver, blue, pink, yellow, and red.

A support layer 3 is inside and next to the color layer 2. The support layer 3 is colored due to the configuration of the color layer 2.

A resin layer 4 inside and next to the support layer 3. The antiseptic layer 1, the color layer 2, and the support layer 3 are melted and joined to the resin layer 4.

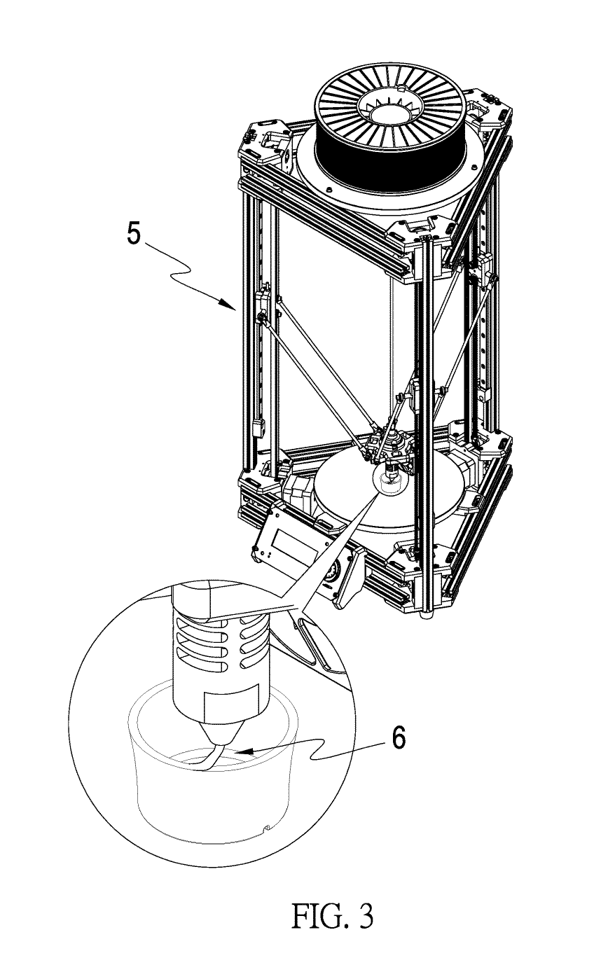

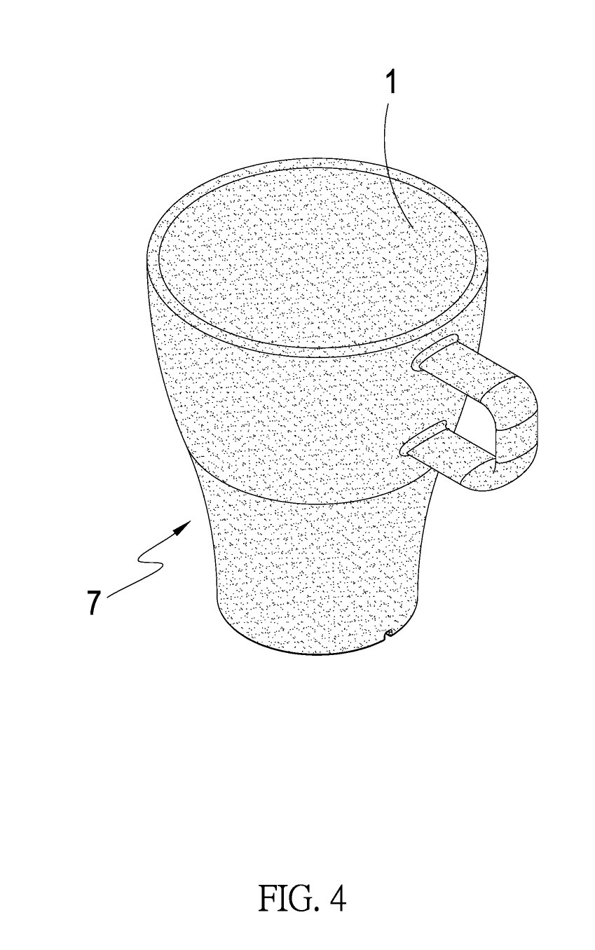

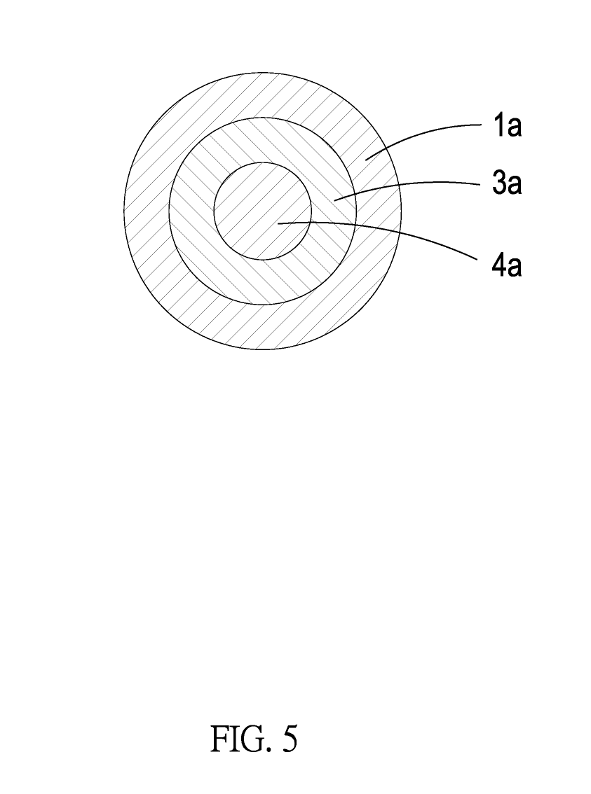

As shown in FIGS. 3 and 4, when an object 7 is produced from a 3D printer 5 using the filament 6, as the filament 6 contains the antiseptic layer 1, the produced object 7 is antiseptic. The antiseptic layer 1 can be customized to have a specific antiseptic effect. During the forming of the filament 6, the melting temperature is between 100 and 500 degrees Celsius, and the filament diameter is between 0.80 and 3.20 mm.

As shown in FIG. 4, the object 7 produced from the 3D printer has the antiseptic layer 1 as its surface so that the object 7 is capable of antisepticising.

As shown in FIG. 5, an antiseptic 3D printing filament according to another embodiment of the present invention contains an antiseptic layer 1a, a support layer 3a, and a resin layer 4a, arranged coaxially and radially outside-in. During the forming of the filament, the melting temperature is between 100 and 500 degrees Celsius, and the filament diameter is between 0.80 and 3.20 mm. Its difference from the previous embodiment is that there is no color layer in the present embodiment. In other words, the filament of the present embodiment is colorless.

Compared to the prior art, the present invention has the following advantages.

Firstly, the filament's antiseptic layer allows the produced object to be antiseptic after production without additional coating or spraying antiseptic material, thereby reducing production time and effort. The filament is also prevented from contamination with prolonged antiseptic capability.

Secondly, the antiseptic layer can be customized to have a specific antiseptic capability.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An antiseptic 3D printing filament comprising the following coaxial layers arranged radially outside-in:
an antiseptic layer;
a color layer inside and next to the antiseptic layer;
a support layer inside and next to the color layer where the support layer is colored due to the configuration of the color layer; and
a resin layer inside and next to the support layer.

2. The antiseptic 3D printing filament according to claim 1, wherein the color layer 2 is made of toner or color masterbatch.

3. The antiseptic 3D printing filament according to claim 1, wherein the antiseptic layer, the color layer, and the support layer are melted and joined to the resin layer.

4. The antiseptic 3D printing filament according to claim 3, wherein the antiseptic layer, the color layer, and the support layer are melted between 100 and 500 degrees Celsius.

5. The antiseptic 3D printing filament according to claim 1, wherein the antiseptic 3D printing filament has a diameter between 0.80 and 3.20 mm.

6. The antiseptic 3D printing filament according to claim 1, wherein the color layer is colorless or has one of the color black, purple, white, green, orange, silver, blue, pink, yellow, and red.

7. An antiseptic 3D printing filament comprising the following coaxial layers arranged radially outside-in:
an antiseptic layer;
a support layer inside and next to the antiseptic layer; and
a resin layer inside and next to the support layer.

8. The antiseptic 3D printing filament according to claim 7, wherein the antiseptic layer, the color layer, and the support layer are melted and joined to the resin layer.

9. The antiseptic 3D printing filament according to claim 8, wherein the antiseptic layer, the color layer, and the support layer are melted between 100 and 500 degrees Celsius.

10. The antiseptic 3D printing filament according to claim 7, wherein the antiseptic 3D printing filament has a diameter between 0.80 and 3.20 mm.
